(19) United States
(12) Patent Application Publication
(10) Pub. No.: US 2003/0033812 A1
(43) Pub. Date: Feb. 20, 2003

(54) Method for cooling turbine blades/vanes

(76) Inventors: Ralf Gerdes, Untersiggenthal (CH); Peter Keller-Sornig, Baden (CH); Bozidar Seketa, Neuenhof (CH); Ilja Tuschy, Heidelberg (DE)

Correspondence Address: Robert S. Swecker, BURNS, DOANE, SWECKER & MATHIS, L.L.P., P.O. Box 1404, Alexandria, VA, 22313-1404, US

(21) Appl. No.: 10/216,279

(22) Filed: Aug. 12, 2002

Related U.S. Application Data
(60) Provisional application No. 60/312,768, filed on Aug. 17, 2001.

(51) Int. Cl. F02C 7/12

(52) U.S. Cl. 60/772; 60/806

(57) ABSTRACT

The present invention relates to a method for cooling the blades/vanes of a main turbine 3 of a gas storage power plant 1, comprising at least:

a gas reservoir 10, in which fresh gas is stored under pressure,

a main turbine 3 with associated burner 6,

a recuperator 7, which associates a fresh gas path 8 with an exhaust gas path 9 so as to transfer heat.

The fresh gas path 8 leads from the gas reservoir 10 through the recuperator 7 and through the burner 6 to the inlet 11 of the main turbine 3. The exhaust gas path 9 leads from the outlet 12 of the main turbine 3 through the recuperator 7 to an exhaust gas plant.

The cooling method comprises the following features:

a cooling gas flow is admitted to the main turbine 3, which cooling gas flow enters the main turbine 3 through the turbine inlet 11,

the cooling gas flow is generated by extracting fresh gas from the gas reservoir 10 and/or by switching on of an external fan or compressor 26, which is directly or indirectly coupled to the inlet 11, and this cooling gas flow is preheated in the recuperator 7.

### FIELD OF THE INVENTION

The invention relates to a method for cooling the blades/vanes of a main turbine of a gas storage power plant.

### BACKGROUND OF THE INVENTION

Gas storage power plants are, for example, known from the report “CAES REDUCED TO PRACTICE” by John Daly, R. M. Loughlin of Dresser-Rand, Mario DeCorso, David Moen of Power Tech Associates, Inc. and Lee Davis of Alabama Electric Cooperative, Inc. This report was presented at “ASME TURBO EXPO 2001”. According to this, a gas storage power plant usually comprises a turbine arrangement with a main turbine and an upstream turbine, a burner being connected upstream of, at least, the main turbine. The turbines are connected, by means of a common turbine shaft, to a generator/electric motor unit. In addition, the gas storage power plant has a compressor arrangement with at least one compressor, which can likewise be connected, by means of a compressor shaft, to the generator/electric motor unit. A gas reservoir, in which fresh gas, for example air, can be stored under pressure, is also provided. During operation to generate electricity, fresh gas is extracted from the gas reservoir and supplied to the turbine arrangement. A recuperator includes a fresh gas path and an exhaust gas path and associates these so as to transfer heat. The fresh gas path leads from the gas reservoir through the recuperator to the turbine arrangement and then continues through the upstream turbine and the burner to the inlet of the main turbine. The exhaust gas path leads from the outlet of the main turbine through the recuperator to an exhaust gas plant. During the operation to generate electricity, the turbines drive the generator/electric motor unit connected to their turbine shaft and driven by it, the generator/electric motor unit being operated as a generator. During an operation to charge the reservoir, the generator/electric motor unit is operated as an electric motor and drives, by means of the compressor shaft which is then connected to it, the compressor or the compressors of the compressor arrangement in order, by this means, to charge the gas reservoir.

Such a gas storage power plant is usually designated a “Compressed Air Energy Storage System”, a CAES system for short. The basic idea of a CAES system consists in the fact that surplus energy, which is generated by permanently operated conventional power station plants during the base-load periods, is temporarily stored in gas reservoirs and is released again via the gas storage power plants in peak-load periods. This is achieved by air or another gas being pumped, with the aid of surplus power, at a relatively high pressure into a reservoir from which the air or the gas can be later extracted, as required, in order to cover the peak load. This means that surplus energy is stored in an available manner in the form of potential energy. Caverns of worked-out coal mines or salt mines or special compressed gas reservoirs are, for example, used as reservoirs.

If the gas storage power plant operation to generate electricity has to be interrupted or terminated, the flow of fresh gas supplied via the fresh gas path is interrupted, for example by a corresponding valve blocking the fresh gas supply to the turbine arrangement. Due to this change in the flow through the turbines, an increase in temperature takes place in the turbine blades/vanes due to dissipative effects. In this case, the danger exists that the blades/vanes may, at least locally, attain unallowably high temperatures. There is, therefore, a demand for a method for cooling the blades/vanes of a main turbine in a gas storage power plant.

In a conventional power station plant with gas turbine, the main turbine drives a compressor, which is directly connected to the main turbine for drive purposes and which generates the high pressure level necessary for the operation of the main turbine. When such a conventional power station plant is switched off, the compressor delivers the cooling air necessary for cooling the main turbine during the run-down.

### SUMMARY OF THE INVENTION

The present invention deals with the problem of demonstrating a method for cooling the turbine blades/vanes of a gas storage power plant. According to the invention, this problem is solved by means of a method with the features of claim 1.

The invention is based on the general idea of using a cooling gas flow for cooling the turbine blades/vanes, which cooling gas flow is produced by an extraction of fresh gas from the gas reservoir of the gas storage power plant and/or by the switching on of an external fan or compressor, which is directly or indirectly connected to the turbine inlet. This procedure permits the provision of a cooling gas flow without excessively large intervention in the existing design of the gas storage power plant. In the case of the gas extraction from the gas reservoir, in particular, the generation of the cooling gas flow takes place without additional demands on externally supplied energy.

If the components to which the cooling gas flow is admitted are not to experience any unallowable thermal stresses, the cooling gas temperature must be located within a specified, fixed or variable, temperature range. Both ambient air and gas stored in the gas reservoir have, as a rule, a temperature that is too low for this purpose. The cooling gas can be expediently preheated in the recuperator, for which purpose it then enters the recuperator on the fresh gas path. In this arrangement, it can be advantageous to branch the cooling gas off the fresh gas path while it is still within the recuperator and to lead it out from the recuperator. With a fixed branch, the branched-off cooling gas then has a temperature which is desired for a standard operating condition of the gas storage power plant. In a special embodiment, the cooling gas can be branched off from the fresh gas path at a plurality of locations within the recuperator and can be led out from the recuperator, it being then possible to adjust the desired cooling gas temperature by a corresponding selection and/or mixing of the various branched-off fresh gas flows.

In addition, it is necessary to ensure that the mass flow of the cooling gas flow is, on the one hand, large enough to yield the desired cooling performance and, on the other hand, is sufficiently small so that it is possible to avoid an acceleration of the main turbine to which it is admitted. In a gas storage power plant which comprises an upstream turbine, it can therefore be expedient to bypass the upstream turbine when supplying the cooling gas flow to the inlet of the main turbine. This procedure is based on the fact that the upstream turbine has smaller blading lengths than the subsequent main turbine, so that the danger of the so-called “windage” is reduced in the case of the upstream turbine. Windage designates dissipative effects which occur in the case of an erroneous flow through turbines with high rotational speed and small throughput and which can cause an additional increase in the temperature of the blades/vanes.

If there is no danger of an acceleration of the turbine rotor, the cooling gas can also be introduced into the fresh gas path before the upstream turbine, by which means the blades/vanes of the upstream turbine are likewise cooled.

As an alternative or additionally, the cooling gas can also be introduced into the fresh gas line directly after the upstream turbine, a cooling gas flow through the upstream turbine in the opposite direction being then generated, with the aid of a blow-off valve arranged in the fresh gas line before the upstream turbine, for part of the cooling gas supplied. In this embodiment, the cooling of the rear blades/vanes, in particular, of the upstream turbine is improved, the danger of acceleration of the upstream turbine being reduced at the same time.

Further important features and advantages of the method according to the invention are provided by the subclaims, from the drawings and from the associated description of the figures using the drawings.

### BRIEF DESCRIPTION OF THE DRAWINGS

Preferred exemplary embodiments are represented in the drawings and are explained in more detail in the following description.

In the drawing, diagrammatically in each case,

FIG. 1 shows a circuit-diagram-type representation, in principle, of a gas storage power plant,

FIG. 2 shows a further simplified representation of the gas storage power plant with a single-shaft arrangement, and

FIG. 3 shows a representation like that of FIG. 2 but with a multi-shaft arrangement.

### DETAILED DESCRIPTION OF THE INVENTION

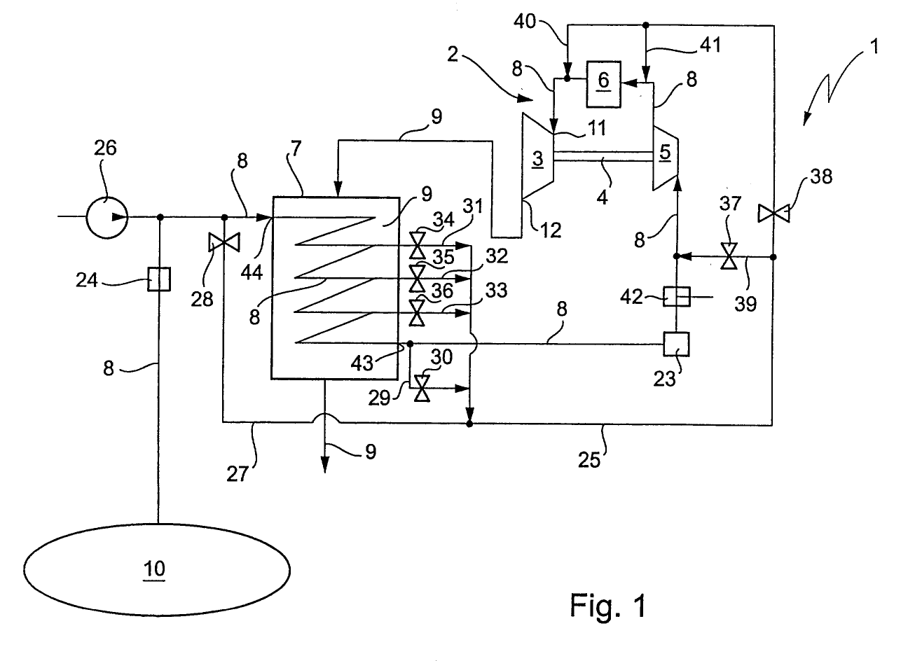

As shown in FIG. 1, a gas storage power plant 1 (here only partially represented) has a turbine arrangement 2 with a main turbine 3 and an upstream turbine 5, which is connected for drive purposes to the main turbine 3 by means of a shaft 4. A burner 6 is associated with the main turbine 3. The gas storage power plant 1 also comprises a recuperator 7, which contains a fresh gas path 8, or a section of it, and an exhaust gas path 9, or a section of it, the fresh gas path 8 and the exhaust gas path 9 being associated in the recuperator 7 so as to transfer heat. In addition, the gas storage power plant 1 comprises a gas reservoir 10, in which fresh gas can be stored under pressure.

Because the fresh gas stored in the gas reservoir 10 is usually air, it is also possible to refer to an air storage power plant 1 and, respectively, to an air turbine 5 and a gas turbine 3.

The fresh gas path 8 begins at the gas reservoir 10, leads through the recuperator 7 to the upstream turbine 5, from the latter to the burner 6 and from this to an inlet 11 of the main turbine 3. For the fresh gas path 8, the recuperator 7 has, correspondingly, an inlet 44 and an outlet 43. The exhaust gas line 9 begins at an outlet 12 of the main turbine 3 and leads through the recuperator 7 to an exhaust gas plant (not shown here) which comprises, for example, a silencer and/or an exhaust gas cleaning device.

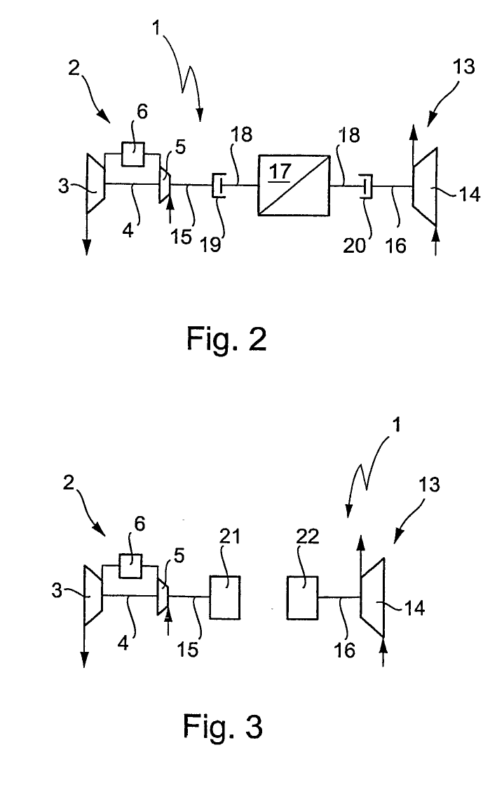

As shown in FIGS. 2 and 3, the gas storage power plant 1 additionally comprises a compressor arrangement 13, which has at least one compressor 14. The turbine arrangement 2 drives a turbine shaft 15 which, as a rule, corresponds to the shaft 4 arranged between the main turbine 3 and the upstream turbine 5 or represents its extension. In a corresponding manner, the compressor 14 is driven by a compressor shaft 16.

In the embodiment shown in FIG. 2, the gas storage power plant 1 has a generator/electric motor unit 17, which can be switched between a generator operation and an electric motor operation. A rotor shaft 18 of this generator/electric motor unit 17 can, on the one hand, be connected by means of a turbine clutch 19 to the turbine shaft 15 and, on the other hand, can be connected by means of a compressor clutch 20 to the compressor shaft 16. Such an arrangement is also designated a single-shaft arrangement.

In the embodiment shown in FIG. 3, the turbine shaft 15 is permanently connected to a generator 21, whereas the compressor shaft 16 is permanently connected to an electric motor 22, which can be operated independently of the generator 21. This design is designated a two-shaft arrangement or, in general, a multi-shaft arrangement.

For electricity generation, fresh gas from the gas reservoir 10 is admitted to the turbine arrangement 2. A valve 23, which is arranged after the recuperator 7 in the fresh gas path 8, opens for this purpose so that the upstream turbine 5, the burner 6 and the main turbine 3 are supplied in sequence with fresh gas. The hot exhaust gases from the main turbine 3 are used in the recuperator 7 for the purpose of preheating the fresh gas flow. A pressure control device 24, which throttles the high storage pressure present in the gas reservoir 10 to a working pressure suitable for the turbine process, is expediently arranged upstream of the recuperator 7 on the fresh air (or fresh gas) side.

If the gas storage power plant 1 operating condition used for electricity generation has to be terminated or interrupted, the valve 23 blocks the fresh gas path 8. In order to ensure that the hot components of the main turbine 3 and the upstream turbine 5 do not overheat, they are cooled by the method according to the invention. In this action, the particular interest is to avoid any overheating of the turbine blades/vanes.

The cooling method proposed according to the invention operates as follows:

A cooling gas flow can be admitted to the main turbine 3, at least, by means of a cooling gas main 25. This cooling gas flow enters the main turbine 3 through the turbine inlet 11. It is expediently generated by an extraction of fresh gas from the gas reservoir 10. As an alternative or additionally, this cooling gas flow can also be generated with the aid of an external fan or compressor 26, which is preferably connected to the fresh gas path 8 before the recuperator 7.

It is fundamentally possible to branch the cooling gas off from the fresh gas path 8, via a branch 27 of the cooling gas main 25, before the recuperator 7 by means of a corresponding actuation of a valve 28. However, the fresh gas at this location is generally too cool to be used as cooling gas. In order to increase the cooling gas temperature, it is for example possible to activate a branch 29, which branches off from the fresh gas path 8 after the recuperator 7 and is connected to the cooling gas main 25. By suitable actuations of a valve 30 and of the valve 28, a desired mixing ratio can be adjusted between a partial flow which flows through the recuperator 7, and is heated in it, and a partial flow which bypasses the recuperator 7 by flowing through the branch 27.

As an alternative or additionally, it is possible to branch off the cooling air at one or a plurality of locations on the fresh gas path 8 within the recuperator 7. For this purpose, corresponding branches 31, 32, 33 can be activated by means of valves 34, 35 and 36. The various branch locations are then selected in such a way that the cooling gas has a different temperature at each branch location. The cooling gas flow, which is then supplied to the turbine arrangement 2 via the cooling gas main 25, can be mixed by corresponding actuations of the valves 28, 30, 34, 35, 36 in order to adjust the desired cooling gas temperature. Fundamentally, a single branch 31, 32 or 33 is sufficient to obtain a cooling gas temperature suitable for a standard operating condition of the gas storage power plant 1. The cooling gas temperature can be matched to the instantaneous operating condition of the gas storage power plant 1 by means of a plurality of branches 31, 32 and 33. The branch 29 for the fresh gas extraction after the recuperator 7 and the branch 27 for the fresh gas extraction before the recuperator 7 can be provided alternatively or additionally in this arrangement, for example as a redundant cooling gas supply.

The cooling gas flow, which has been generated and moderated in the manner described above, is now supplied to the turbine arrangement 2 so as to bypass the closed valve 23. As an example, the cooling gas flow can be introduced into the fresh gas path 8 after the valve 23 by a corresponding actuation of valves 37 and 38. Fundamentally, the possibility exists of introducing the cooling gas into the fresh gas path 8 before the upstream turbine 5 by means of a branch 39. It is likewise possible to introduce the cooling gas flow into the fresh gas path 8 still within the valve 23 but after a shut-off element of the control valve 23. With this type of cooled gas introduction, both the main turbine 3 and the upstream turbine 5 can be cooled. It is likewise possible to introduce the cooling gas into the fresh gas path 8, by means of a branch 40, after the upstream turbine 5 and after the burner 6 or, by means of a branch 41, after the upstream turbine 5 and before the burner 6. If both branches 40 and 41 are realized, corresponding control devices must be provided for their reciprocal activation. Where the cooling gas is introduced directly at the inlet 11 of the main turbine 3, the fresh gas path 8 does not participate in the guidance of the cooling gas flow—as a departure from the variants previously mentioned. The cooling gas flow can therefore be introduced directly into the casing of the main turbine 3.

A particularly important embodiment is one in which a blow-off valve 42 is arranged between the upstream turbine and the valve 23 in the fresh gas path 8. When activated, this blow-off valve 42 permits gas to emerge from the fresh gas path 8 into the surroundings or into the exhaust gas path 9, for example. If the cooling gas flow is now introduced into the fresh gas path 8 after the upstream turbine 5, for example via the branch 40 or via the branch 41, a branching of the cooling gas flow into two partial flows can be specifically adjusted by means of an activation of the blow-off valve 42. Whereas one partial flow flows, as previously, through the main turbine 3, the other partial flow flows through the upstream turbine 5 in the counterflow direction and emerges from the fresh gas path 8 via the blow-off valve 42.

A plurality of variants of the cooling gas introduction can be realized simultaneously in order, for example, to make redundant systems available by this means.

The introduction of cooling gas before the upstream turbine 5 ensures, on the one hand, the intensive cooling of the upstream turbine 5 and the main turbine 3. On the other hand, however, the volume flow necessary for the cooling of the main turbine 3 can be so large that the danger of an acceleration of the turbines 3 and 5 exists due to the flow through the upstream turbine 5. The introduction of the cooling flow after the upstream turbine 5 without opposite flow through the upstream turbine 5 ensures reliable cooling of the main turbine 3 but neglects the cooling of the upstream turbine 5 and, in particular, risks an inadequate cooling in the case of windage of the same. The extent of the windage in the upstream turbine 5 is, however, small because the upstream turbine 5 has comparatively short blades/vanes due to the relatively high pressure level with which it is operated during normal operation and, in addition to the peripheral velocity, the length of the blades/vanes is decisive in terms of the extent of the windage.

In the case of the cooling gas supply after the upstream turbine 5 with a flow through the upstream turbine 5 in the counterflow direction, it is possible to ensure adequate cooling for both the main turbine 3 and the upstream turbine 5, the danger of an acceleration of the turbines 3 and 5 being, in addition, effectively countered.

The cooling method according to the invention is suitable both for a gas storage power plant 1 with the single-shaft arrangement as shown in FIG. 2 and for a gas storage power plant 1 with a two-shaft or multi-shaft arrangement as shown in FIG. 3. It is fundamentally possible to use the compressor 14 of the compressor arrangement 13 from FIGS. 2 and 3 for generating the cooling gas flow and to expediently replace the fan or compressor 26 from FIG. 1.

List of Designations

1 Gas storage power plant

2 Turbine arrangement

3 Main turbine

4 Shaft

5 Upstream turbine

6 Burner

7 Recuperator

8 Fresh gas path

9 Exhaust gas path

10 Gas reservoir

11 Inlet of 3

12 Outlet of 3

13 Compressor arrangement

14 Compressor

15 Turbine shaft

16 Compressor shaft

17 Generator/electric motor unit

18 Rotor shaft

19 Turbine clutch

20 Compressor clutch

21 Generator

22 Electric motor

23 Valve

24 Pressure control device

25 Cooling gas main

26 Fan/compressor

27 Branch of 25

28 Valve in 27

29 Branch of 25

30 Valve in 29

31 Branch of 25

32 Branch of 25

33 Branch of 25

34 Valve in 31

35 Valve in 32

36 Valve in 33

37 Valve in 39

38 Valve in 25

39 Branch of 25

40 Branch of 25

41 Branch of 25

42 Blow-off valve

43 Outlet of 7

44 Inlet of 7

1. A method for cooling the blades/vanes, in particular, of a main turbine (3) of a gas storage power plant (1), comprising
a gas reservoir (10), in which fresh gas is stored under pressure,
a main turbine (3) with associated burner (6),
a recuperator (7), which contains a fresh gas path (8) and an exhaust gas path (9) and associates these so as to transfer heat, the fresh gas path (8) leading from the gas reservoir (10) through the recuperator (7) and through the burner (6) to the inlet (11) of the main turbine (3), whereas the exhaust gas path (9) leads from the outlet (12) of the main turbine (3) through the recuperator (7) to an exhaust gas plant,
having the following features:
a cooling gas flow is admitted to the main turbine (3), which cooling gas flow enters the main turbine (3) through the turbine inlet (11),
the cooling gas flow is generated by a fresh gas extraction from the gas reservoir (10) and/or by switching on of an external fan or compressor (26), which is directly or indirectly connected to the inlet (11) of the main turbine (3).

2. The method as claimed in claim 1, characterized in that the cooling gas is preheated in the recuperator (7), the cooling gas entering the recuperator (7) on the fresh gas path (8).

3. The method as claimed in claim 1 or 2, characterized in that, the cooling gas enters the recuperator (7) on the fresh gas path (8) through an inlet (44) of the recuperator (7) and is branched off from the fresh gas path (8) before an outlet (43) of the recuperator (7) and is led out of the recuperator (7).

4. The method as claimed in claim 3, characterized in that the cooling gas is branched off in the recuperator (7) at a location in the fresh gas path (8), which is selected in such a way that the cooling gas branched off has a temperature which has previously been determined for a standard operating condition of the gas storage power plant (1).

5. The method as claimed in claim 3 or 4, characterized in that the cooling gas is branched off from the fresh gas path (8) at a plurality of locations in the recuperator (7), which locations are selected in such a way that the cooling gas branched off has a different temperature at each branch location, one or a plurality of branches being specifically activated for the generation of a cooling gas flow with a desired temperature.

6. The method as claimed in one of claims 1 to 5, characterized in that in order to generate a cooling gas flow with a desired temperature, unheated cooling gas is mixed, after the recuperator (7), with the cooling gas heated in the recuperator (7).

7. The method as claimed in claim 6, characterized in that, in order to moderate its temperature, the cooling gas flow is divided into two partial flows before the recuperator (7), one partial flow entering the recuperator (7) whereas the other partial flow bypasses the recuperator (7), the two partial flows being combined after the recuperator (7) as a function of the desired cooling gas temperature.

8. The method as claimed in one of claims 1 to 7, characterized in that, in the case of a gas storage power plant (1) which contains, in the fresh gas path (8) after the recuperator (7), a valve (23) for controlling the supply of fresh gas to the downstream components (5, 6, 3), the cooling gas flow bypasses the valve (23) when being led to the turbine inlet (11).

9. The method as claimed in one of claims 1 to 8, characterized in that, in the case of a gas storage power plant (1) which has, in the fresh gas path (8) before the burner (6), an upstream turbine (5) which is connected for drive purposes to the main turbine (3), the cooling gas flow at least partially bypasses the upstream turbine (5) when being supplied to the inlet (11) of the main turbine (3).

10. The method as claimed in claim 9, characterized in that the cooling gas flow is directly supplied through the inlet (11) of the main turbine (3) or is introduced into the fresh gas path (8) between the upstream turbine (5) and the main turbine (3).

11. The method as claimed in one of claims 1 to 10, characterized in that, in the case of a gas storage power plant (1) which has, in the fresh gas path (8) before the burner (6), an upstream turbine (5) connected for drive purposes to the main turbine (3), the cooling gas flow is at least partially introduced into the fresh gas path (8) before the upstream turbine (5).

12. The method as claimed in claim 11, characterized in that, in the case of a gas storage power plant (1) which has a valve (23) before the upstream turbine (5) in the fresh gas path (8), the cooling gas flow is introduced into the fresh gas path (8) after the valve (23) or within the valve (23) after its shut-off element.

13. The method as claimed in one of claims 1 to 12, characterized in that, in the case of a gas storage power plant (1) which has, in the fresh gas path (8) before the burner (6), an upstream turbine (5) which is connected for drive purposes to the main turbine (3) and which gas storage power plant contains a blow-off valve (42) in the fresh gas path (8) before the upstream turbine (5), the cooling gas flow is introduced into the fresh gas path (8) between the upstream turbine (5) and the main turbine (3), the cooling gas flow being divided into two partial flows, of which one partial flow flows through the main turbine (3) whereas the other partial flow flows through the upstream turbine (5) in the counterflow direction and emerges from the fresh gas path (8) through the blow-off valve (42).

14. The method as claimed in one of claims 1 to 13, characterized in that the main turbine (3) drives a turbine shaft (15), in that the gas storage power plant (1) has at least one compressor (14) which can be driven by means of a compressor shaft (16), and in that the gas storage power plant (1) has a generator/electric motor unit (17), which can be switched over between a generator operation, in which the generator/electric motor unit (17) is connected to the turbine shaft (15) for drive purposes, and an electric motor operation, in which the generator/electric motor unit (17) is connected to the compressor shaft (16) for drive purposes.

15. The method as claimed in one of claims 1 to 13, characterized in that the gas storage power plant (1) has a generator (21), which is connected to the turbine shaft (15) for drive purposes, and an electric motor (22), which can be operated independently of the generator (21) and which is connected to the compressor shaft (16) for drive purposes.
